(19) United States
(12) Patent Application Publication
(10) Pub. No.: US 2010/0045879 A1
(43) Pub. Date: Feb. 25, 2010

(54) MATRIX DISPLAY INTERFACE FOR PRESENTATION SYSTEM

(75) Inventor: Ming Jang Chen, Hsinchu City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: National Chiao Tung University, Hsinchu City (TW)

(21) Appl. No.: 12/545,295

(22) Filed: Aug. 21, 2009

(30) Foreign Application Priority Data
Aug. 22, 2008 (TW) 097132328

(51) Int. Cl. H04N 9/31

(52) U.S. Cl. 348/744; 348/E09.025

(57) ABSTRACT

A matrix display interface for a presentation system includes a plurality of data units, a main switching element, a plurality of column switching elements, a plurality of row switching element, and a plurality of grid switching elements. The data units are arranged on a display interface and are written with presentation data in advance. The presentation system is operated on a computer. A user may click the switching elements to selectively display or conceal or highlight all the data units, a whole column of data units, a whole row of data units, or a single data unit. Thereby, a speaker of a presentation may selectively present the content of the presentation to draw the attention of the listeners, so that the speaker and the listeners may have positive interactions during the presentation.

### CROSS-REFERENCE TO RELATED APPLICATIONS

This non-provisional application claims priority under 35 U.S.C. §119(a) on Patent Application No(s). 097132328 filed in Taiwan, R.O.C. on Aug. 22, 2008, the entire contents of which are hereby incorporated by reference.

### BACKGROUND OF THE INVENTION

1. Field of Invention

The present invention relates to a presentation system, and more particularly, to a matrix display interface for a presentation system.

2. Related Art

A presentation is a process in which a speaker briefly introduces the content of a report on some subject and also conveys messages or viewpoints to the listeners. In a conventional conference presentation, the speaker usually records the content, messages, etc., to be presented in a slide in the form of texts or graphics, and then projects the content, messages, etc., onto a cloth screen with a projector. By reading these texts and graphics, the listeners may better understand and grasp the content of the presentation. However, the slide adopted by the conventional presentation is generally a physical transparent plastic sheet, and a blank slide is further required when the content of the presentation needs to be altered, which not only leads to a waste of resources, but also causes environmental pollution. With the popularization of computers, computer presentation software, for example, PowerPoint, Graphics, or Freelance is utilized for conference presentation, and thus the content of the presentation is configured into a digital file and projected onto a cloth screen by a digital projector. For the content of the presentation, in addition to texts and graphics, audio/video clips may also be added into this digital presentation file, so as to make the presentation more interesting and attractive. However, no matter the presentation is made in the form of a conventional slide or a digital presentation file, how to draw the attention of the listeners is always a matter to be concerned by the speaker.

Taking the commonly used presentation software PowerPoint as an example, if the content of a single slide is presented once, the listeners may easily neglect the speaker's speech by reading the content of the presentation, and find it difficult to concentrate on the current speech as too much information is given. The presentation software enables the presentation file to be designed with an animation content, and the slide is controlled by clicking the mouse to display the content of the slide step by step, so as to gradually display the whole content of the slide. However, it is rather complicated to edit the animation in the slide, and thus it takes a longer time to fabricate the slide. Besides, during the presentation, the texts or graphics in some paragraphs cannot be displayed or concealed repeatedly. In addition, as the content presented by the current slide animation is the content edited in advance, the presentation manner is quite monotonous. For example, if the texts in the animation are required to be gradually displayed from the first to the last column, the presentation needs to be made in a predetermined sequence. Thereby, the speaker is unable to decide the displaying sequence based on the interaction with the listeners during the presentation.

### SUMMARY OF THE INVENTION

In order to eliminate the defects that the presentation preparing process is too complicated and it is impossible to repeatedly display or conceal part of the content of the presentation, the present invention provides a matrix display interface for a presentation system. When a presenter operates the presentation system on a computer, a main switching element, column switching elements, row switching elements, and grid switching elements are utilized to selectively display or conceal or highlight a part of the content of the presentation data. Thereby, the listeners to the presentation may better understand the content of the presentation, and the interactions between the presenter and the listeners are enhanced. In addition, the present invention is also meant to switch to display or conceal or highlight at least one data unit with a plurality of switching elements, so as to selectively display or conceal or highlight the content of the presentation.

To achieve the above objectives, a matrix display interface for a presentation system provided by the present invention comprises a plurality of data units, a main switching element, a plurality of column switching elements, a plurality of row switching elements, and a plurality of the grid switching elements. The data units are arranged on a display interface of the presentation system, and written with presentation data by a presenter in advance. The main switching element has a first prompt text, for switching to display or conceal all the data units when clicked. The column switching element has a second prompt text, for switching to display or conceal a whole column of the corresponding data units when clicked. The row switching element has a third prompt text, for switching to display or conceal a whole row of the corresponding data units when clicked. The grid switching element is corresponding to the data units, for switching to display or conceal the corresponding data units when clicked.

In the matrix display interface for a presentation system according to a preferred embodiment of the present invention, the presentation data may be texts, graphics, video files, or audio files. In the matrix display interface for a presentation system according to a preferred embodiment of the present invention, an arrangement mode of the data units may be no-interval checkerboard arrangement, equal interval checkerboard arrangement, or unequal interval checkerboard arrangement.

In the matrix display interface for a presentation system according to a preferred embodiment of the present invention, when a horizontal axis coordinates range of the data units and a horizontal axis coordinates range of the column switching elements are intersected, it is determined that the data units are corresponding to the column switching elements. Similarly, when a vertical axis coordinates range of the data units and a vertical axis coordinates range of the row switching elements are intersected, it is determined that the data units are corresponding to the row switching elements.

In the matrix display interface for a presentation system according to a preferred embodiment of the present invention, an arrangement mode of the column switching elements comprises single-row adjacent juxtaposition, single-row interval juxtaposition, multiple-row adjacent juxtaposition, and multiple-row interval juxtaposition, and an arrangement mode of the row switching elements comprises single-row adjacent juxtaposition, single-row interval juxtaposition, multiple-row adjacent juxtaposition, and multiple-row interval juxtaposition.

In the matrix display interface for a presentation system according to a preferred embodiment of the present invention, a display type of the main switching element may be a transparent element with a ground color, an opaque element with a ground color, a transparent element without a ground color, or an opaque element without a ground color; a display type of the column switching elements may be a transparent element with a ground color, an opaque element with a ground color, a transparent element without a ground color, or an opaque element without a ground color; a display type of the row switching elements may be a transparent element with a ground color, an opaque element with a ground color, a transparent element without a ground color, or an opaque element without a ground color; and a display type of the grid switching elements may be a transparent element with a ground color, an opaque element with a ground color, a transparent element without a ground color, or an opaque element without a ground color.

Further, a matrix display interface for a presentation system provided by the present invention comprises a plurality of data units and at least one switching element. The data units are arranged on a display interface, and written with presentation data in advance. The switching element has a prompt text, for switching to display or conceal the corresponding data units when clicked.

In view of the above, the matrix display interface for a presentation system provided by the present invention is to control with the main switching element all the data units in the display interface of the presentation system to be displayed or concealed at the same time, also to control with the column switching element or row switching element a whole column or a whole row of the data units to be displayed or concealed at the same time, and to control with the grid switching element a single data unit to be displayed or concealed. Thereby, the presenter is able to control the display interface to show the key points of the current presentation upon requirements, so that the listeners may easily focus on the content of the presentation.

For purposes of summarizing, some aspects, advantages and features of some embodiments of the invention have been described in this summary. Not necessarily all of (or any of) these summarized aspects, advantages or features will be embodied in any particular embodiment of the invention. Some of these summarized aspects, advantages and features and other aspects, advantages and features may become more fully apparent from the following detailed description and the appended claims.

### BRIEF DESCRIPTION OF THE DRAWINGS

The present invention will become more fully understood from the detailed description given herein below for illustration only, and thus are not limitative of the present invention, and wherein:

FIGS. 1A to 1F are schematic views of a matrix display interface for a presentation system according to a preferred embodiment of the present invention;

FIG. 2 is a schematic view of a matrix display interface for a presentation system according to another preferred embodiment of the present invention;

FIG. 3A is a schematic view of an interface according to another implementation aspect of the present invention;

FIG. 3B is a schematic view of a display frame according to another implementation aspect of the present invention;

FIG. 4A is a schematic view of another implementation aspect of the present invention;

FIG. 4B is a schematic view of converting presentation data in a table into data units;

FIG. 4C is a schematic view of a display interface and mask units; and

FIG. 4D is a schematic view before the mask units are switched.

### DETAILED DESCRIPTION OF THE INVENTION

The objectives and method of the present invention are described in detail below with preferred embodiments, and the concept of the present invention may also be applied to other scopes. The embodiments below are only used to illustrate the objectives and method of the present invention, instead of limiting the scope of the same.

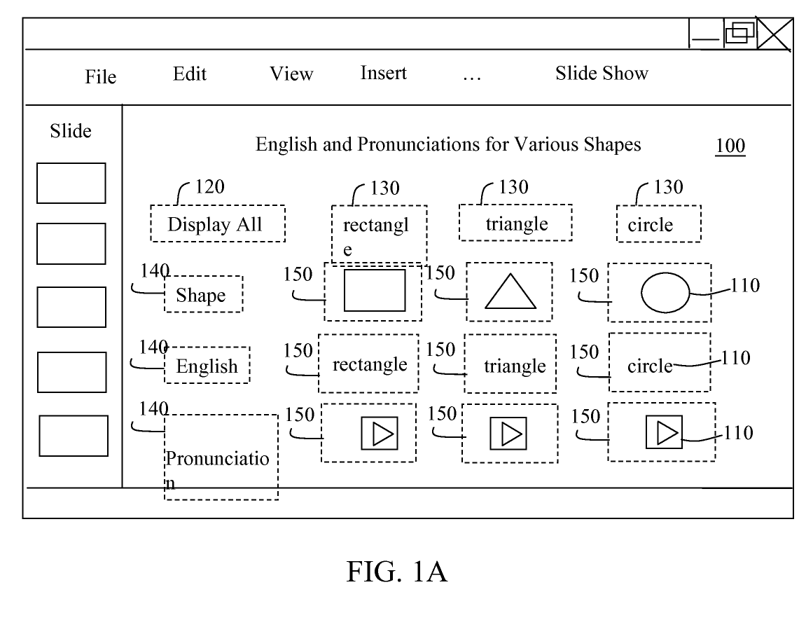

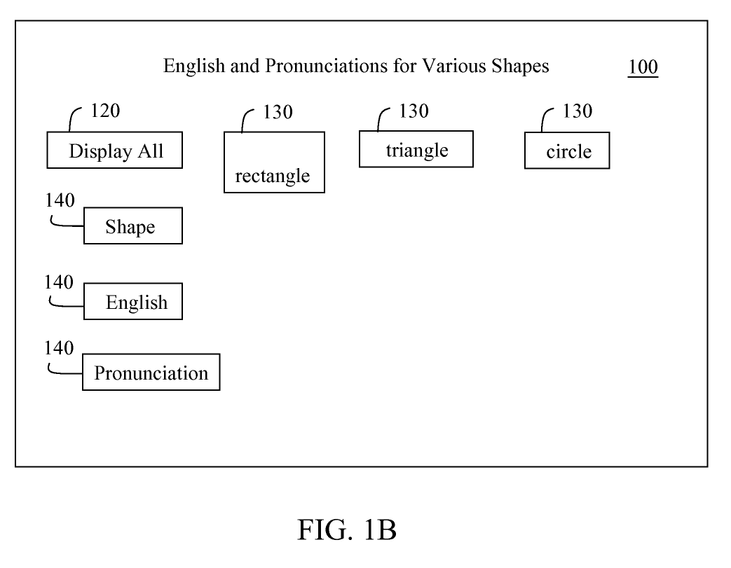

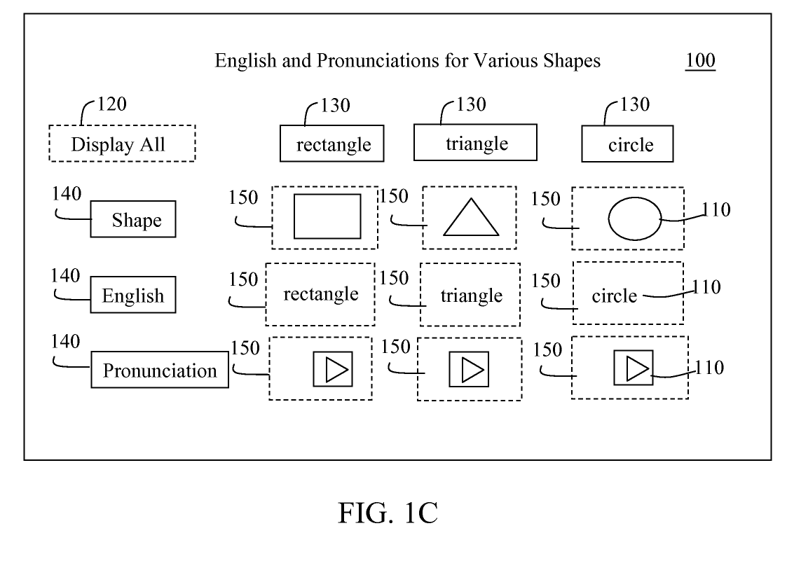

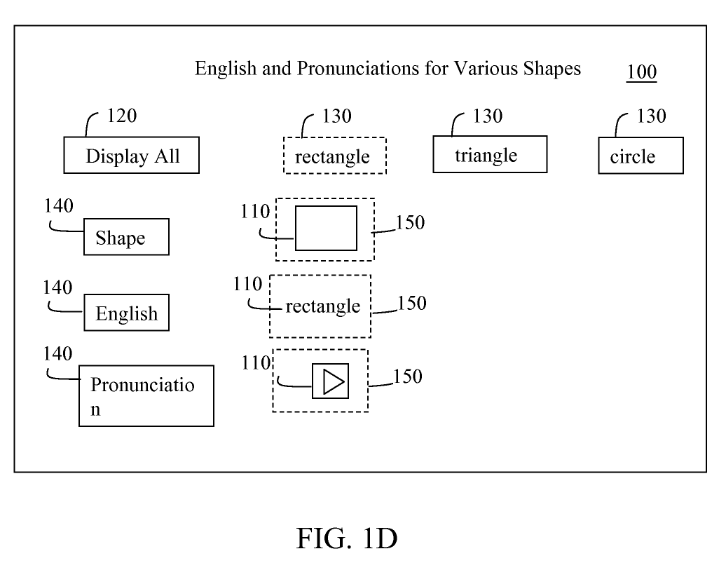

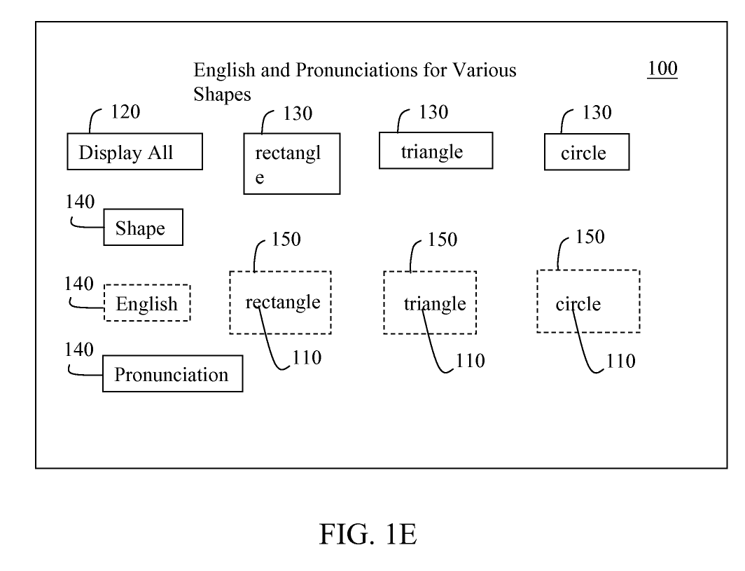

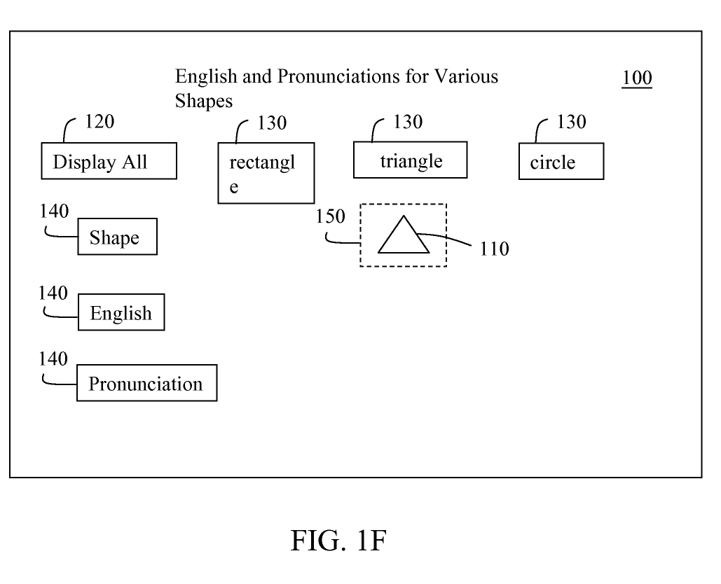

A matrix display interface for a presentation system provided by the present invention is applicable to slide presentations, speeches, or teaching activities with a computer. Through the display interface, presentation data such as texts, graphics, video files, and audio files are presented in the manner of push-button dynamic presentation (that is, the presentation information is controlled to be displayed or concealed dynamically by specific switching elements), such that the listeners may focus on the part currently illustrated by the speaker. FIGS. 1A to 1F are schematic views of a matrix display interface for a presentation system according to a preferred embodiment of the present invention. First referring to FIG. 1A, the matrix display interface for a presentation system (that is, the display interface 100 in FIG. 1A) comprises a plurality of data units 110, a main switching element 120, a plurality of column switching elements 130, a plurality of row switching element 140, and a plurality of grid switching elements 150. A display type of the switching elements may be a transparent element with a ground color, an opaque element with a ground color, a transparent element without a ground color, or an opaque element without a ground color, or added with a pointer. The pointer here means that the objects are highlighted with a frame or a color. Taking the commonly used presentation software PowerPoint as an example, the main switching element 120, the plurality of column switching elements 130, the plurality of row switching elements 140, and the plurality of grid switching elements 150 are in a mode of push-button and message presentation. The functions of appearing and concealing in PowerPoint animation are used to simply replace the complicated settings in PowerPoint. This embodiment only takes a PowerPoint presentation system as an example, and the concepts of messages related to presenting and concealing are displayed by buttons in the presentation frame. Definitely, the present invention may also be applied to other presentation software, and the scope of the invention is not limited herein.

A presenter first writes (edits) the presentation data into each data unit 110 in advance, and arranges the data units 110 within the display interface 100. The written presentation data may be, for example, texts, graphics, video files, and audio files. The data units 110 may be input by filling in corresponding positions one by one in the form of tables by using PowerPoint, Word, or Excel. Next, for the present invention, the data in the table is converted into arrangements of the data units 110 at corresponding positions. Besides, the data units 110 may also be keyed in one by one on the display interface of the present invention. English teaching is taken as an example in this embodiment. A presenter first fills in each data unit 110 with information about the content of the presentation such as English for various shapes like rectangle, triangle, and circle, the shapes, and pronunciations thereof. Afterward, the presenter sets the main switching element 120 and fills in a first prompt text “Display All”, then fills in each column switching element 130 with a second prompt text “Chinese for Various Shapes” in advance, fills in each row switching element 140 with a third prompt text in advance, and sets the corresponding grid switching element 150 for each data unit 110. An arrangement mode of the data units 110 may be, for example, no-interval checkerboard arrangement, equal interval checkerboard arrangement, or unequal interval checkerboard arrangement.

In this embodiment, the arrangement is equal interval checkerboard arrangement, and the present invention is not limited thereto. The main switching element 120 is marked with a first prompt text, for example, “Display All”. When clicked, the main switching element 120 switches to display or conceal all the data units 110 in the display interface 100. Further, each column switching element 130 is filled with a second prompt text. During the presentation, when clicked, the column switching elements 130 switch to display or conceal a whole column of the data units. Each row switching element 140 also has a third prompt text for prompting the presenter to click the switch. When clicked, the row switching elements 140 switch to display or conceal a whole row of the corresponding data units 1 10. In addition, each data unit 110 is set with a corresponding grid switching element 150 (at least one), and the presenter clicks the grid switching elements 150 to display or conceal the corresponding data units 1 10.

In this embodiment, for the presentation system, it is determined whether the data units 110 are corresponding to the column switching elements 130 or the row switching element 140 according to a horizontal axis coordinates range and a vertical axis coordinates range of the data units 1 10. If the horizontal axis coordinates range of the data units 110 and the horizontal axis coordinates range of the column switching elements 130 are intersected, it is determined that the data units 110 are corresponding to the column switching elements 130. Similarly, if the vertical axis coordinates range of the data units 110 and the vertical axis coordinates range of the row switching element 140 are intersected, it is determined that the data units 110 are corresponding to the row switching elements 140.

Further, the column switching elements 130 may be arranged by the presenter into single-row adjacent juxtaposition, single-row interval juxtaposition, multiple-row adjacent juxtaposition, or multiple-row interval juxtaposition. The row switching elements 140 may also be arranged into single-column adjacent juxtaposition, single-column interval juxtaposition, multiple-column adjacent juxtaposition, or multiple-column interval juxtaposition, and the arrangement mode thereof is not limited herein. Referring to FIG. 1B, after the presenter clicks the main switching element 120 for the first time, all the data units 110 are concealed, and only the main switching element 120, the column switching elements 130, and the row switching elements 140 are left, and thus the presenter starts presenting/teaching. Referring to FIG. 1C, when the presenter clicks the main switching element 120 again, all the data units 110 are displayed. Each data unit 110 has its corresponding grid switching element 150. When all the data units 110 are displayed, the presenter may click the corresponding grid switching elements 150 to conceal the selected data units 11 0. When the presenter clicks the main switching element 120 at this time, all the data units 110 are concealed again.

Referring to FIG. 1D, the presenter clicks the column switching element 130 (a push button written with a prompt text of “rectangle”) to display the whole column of the data units 110 related to “rectangle”, as shown by the data unit 110 and its corresponding grid switching element 150 in FIG. 1D. Definitely, the presenter may also set a switch for controlling the play of multimedia video and audio files in each grid switching element 150, and the switch is not limited herein.

Referring to FIG. 1E, after the presenter employs the main switching element 120 to conceal all the data units 110, and clicks the row switching element 140 (a push-button switch written with the third prompt text of “English”), the whole row of the data units 110 (in this embodiment, for example, English words for all the shapes) are then displayed. Thereby, the listeners may clearly obtain related presentation information through the second prompt text of the column switching element 130 and the third prompt text of the row switching element 140. Referring to FIG IF, when all the data units 110 are concealed, the presenter clicks the grid switching element 150 at the second column and second row, so as to display the corresponding data unit 110, and the listeners may have a vivid understanding about the geometry of a triangle. Definitely, the presenter may repeatedly display or conceal the data units 110 depending on presentation/teaching requirements. In comparison with the non-repeatability of the presentation animation in the past, the present invention also provides flexibility in teaching.

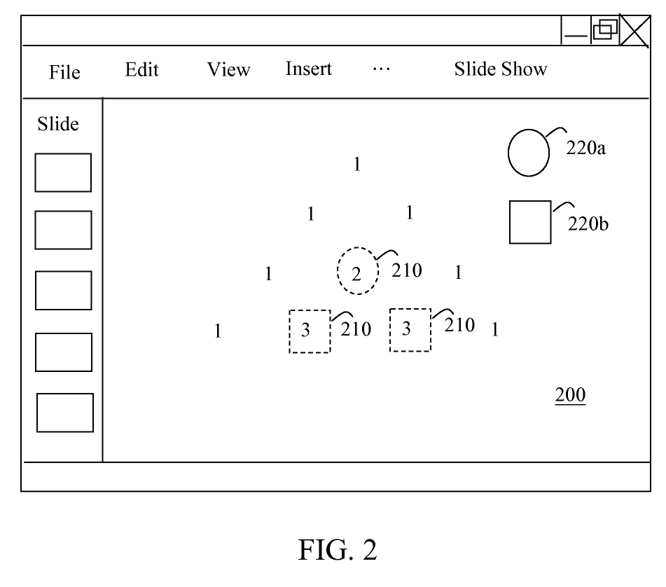

Another teaching objective is taken as an example below. FIG. 2 is a schematic view of a matrix display interface for a presentation system according to another preferred embodiment of the present invention. Referring to FIG. 2, the teaching of the Pascal triangle is shown in this embodiment. A presenter fills in data units 210a, 210b with corresponding teaching content in advance, and sets corresponding switching elements 220a, 220b for the data units. In this embodiment, it is not limited that the switching elements 220a, 220b have to overlap the corresponding data units 110. When the presenter clicks the switching element 220a, the switching element 220a switches to display the corresponding data unit 210a. When the presenter clicks the switching element 220b, the switching element 220b switches to display the corresponding data unit 210b. The teachings or presentations about other contents such as multiplication table, magic square, and poems may also be realized in the form of tables by using the present invention, and messages in any part of a table may be displayed/concealed/highlighted repeatedly. Thereby, the presentation/teaching is more flexible, and interactions between the presenter and the listeners are enhanced.

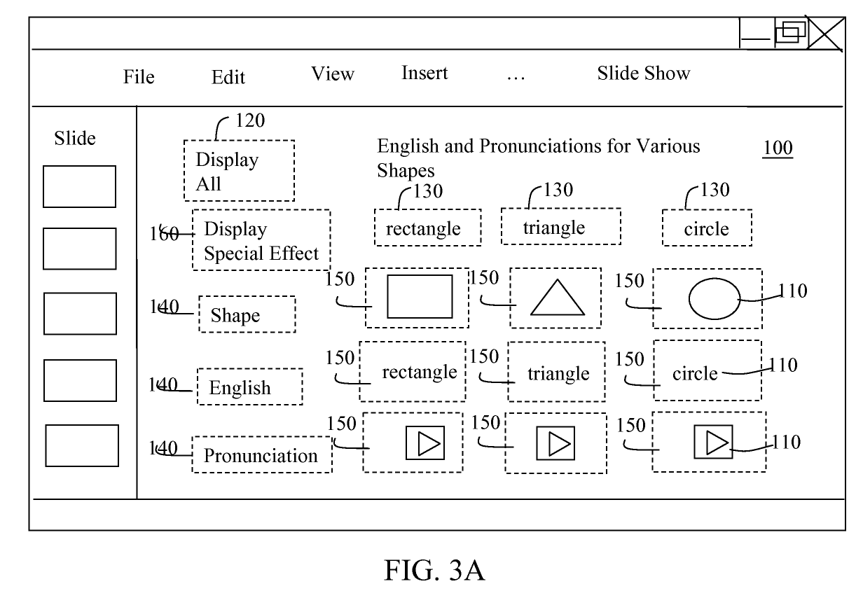

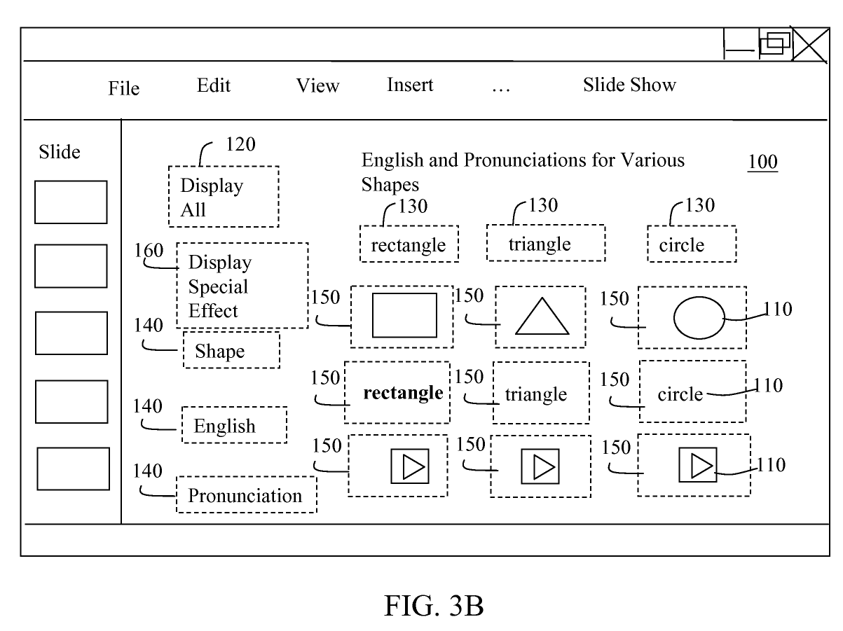

Another implementation aspect is described below. FIG. 3A is a schematic view of an interface according to another implementation aspect of the present invention. In this implementation aspect, in addition to the aforementioned switches, the interface further comprises a special effect switching element 160. The number of the special effect switching element 160 is determined by the number of the data units 110. The combining relationship of the above switches may be referred to the previous content, and the details will not be given herein again. The special effect switching element 160 in this implementation aspect is used to play a display special effect of the data units 110 or to add the aforementioned pointer, for example, an item that may be added around the data to draw the attention of the user without affecting the data itself, for example, a frame or color different from that of the object. The display special effect is to switch the content of the presentation data written into the data units 110 and alter its play property, so as to enhance the impression of the listeners. In order to more clearly describe the differences from the foregoing implementation aspect, the above example of English teaching is still employed for illustration.

The presenter sets the special effect switch 160 and fills in a fourth prompt text “Display Special Effect”. Besides writing (editing) in advance the presentation data in each data unit 110, the presenter may also set display properties of different special effects in each data unit 110. For example, if texts are stored in the data units 110, the font type, font size, or font color may be set for the texts. When the presenter starts the presentation, the presenter may play the corresponding data units 110 on the display frame according to different combinations of the column switching elements 130 and the row switching elements 140. Meanwhile, the presenter may further click the special effect switching element 160 to play the display special effect of the set data units 110. In this manner, the visual impression of the listeners is further enhanced. FIG. 3B is a schematic view of a display frame according to another implementation aspect of the present invention. The properties of the texts are modified in FIG. 3B, so as to highlight the differences between the presentation focuses and the other texts.

If a multimedia file (a picture, a piece of music, or a film) is stored in the data units 110, the presenter may add special effects such as shrink, enlargement, and fade-in/fade-out according to different play situations, thereby enhancing the impression of the listeners during the presentation.

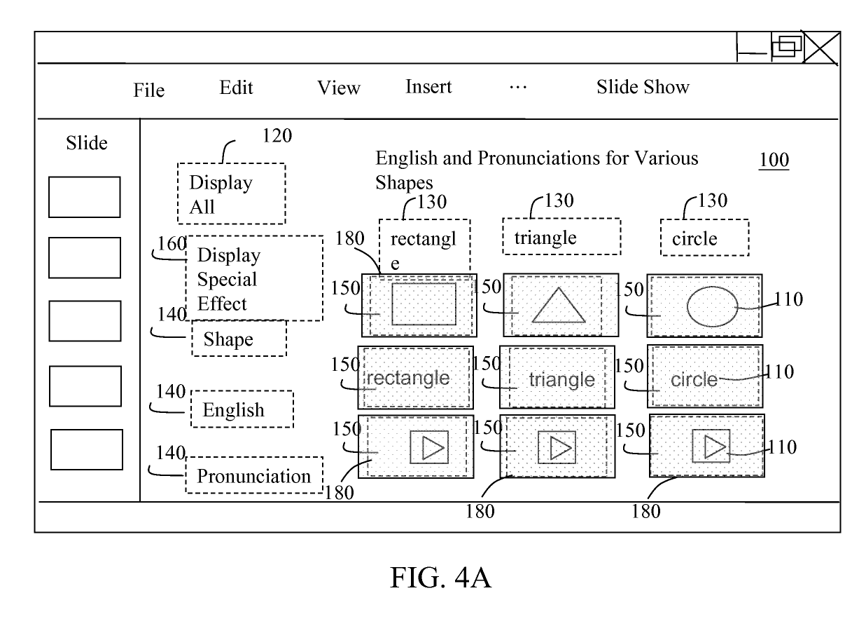

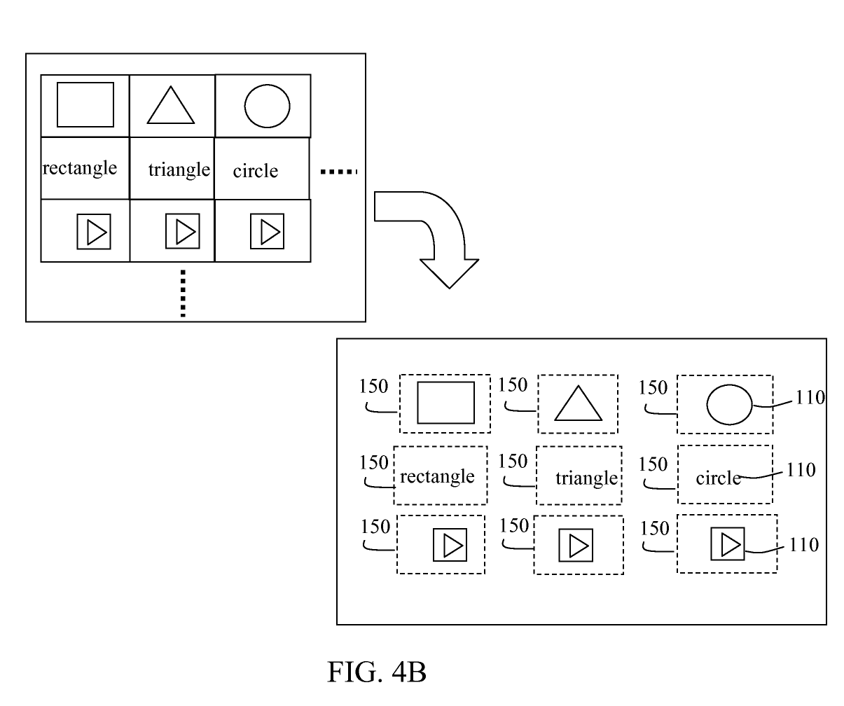

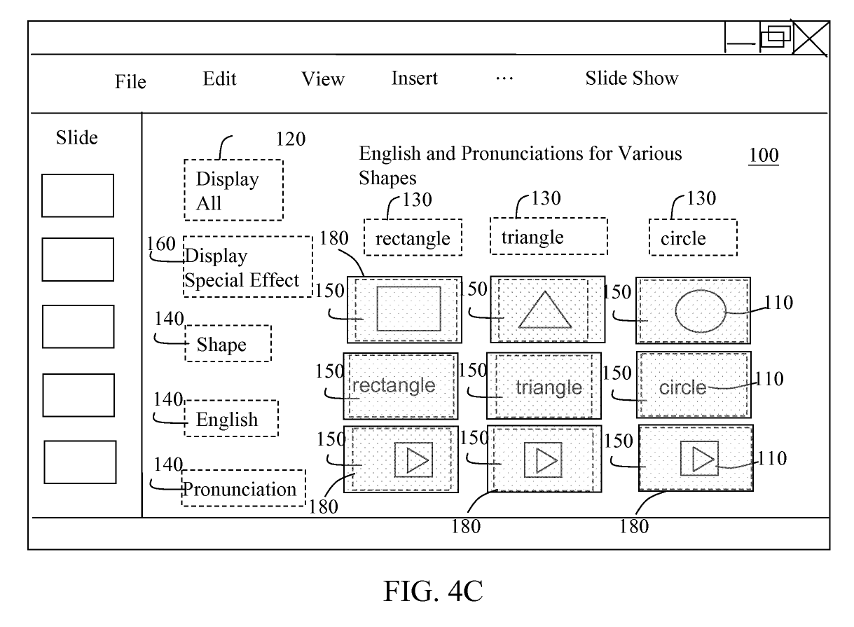

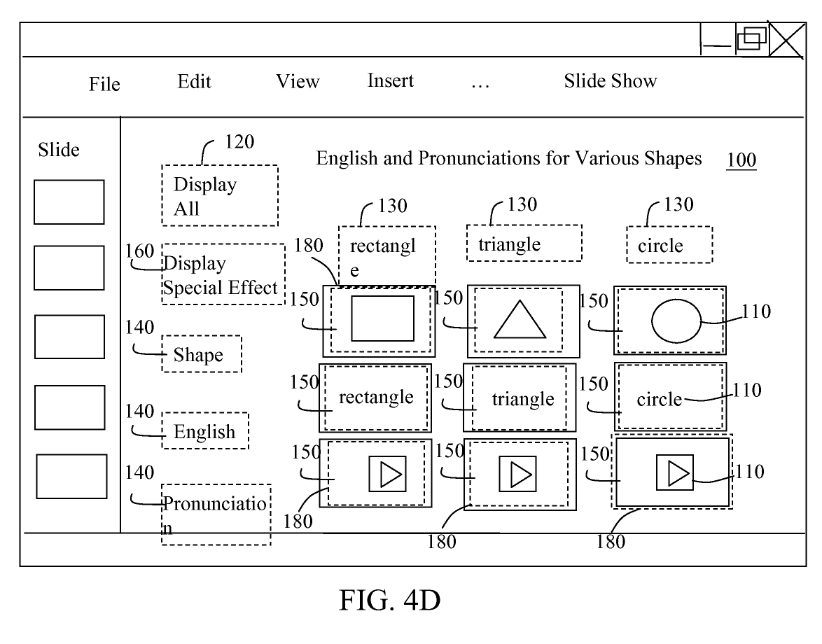

In each of the aforementioned implementation aspects, each data unit 110 is switched to be displayed or concealed, so as to highlight the focuses of the presentation. Besides the foregoing implementation aspects, the present invention may be further applied to the following changes. FIG. 4A is a schematic view of another implementation aspect of the present invention. First, the presenter loads a table containing a plurality of presentation data into the presentation system. FIG. 4B is a schematic view of converting presentation data in a table into the data units. Next, the presentation system writes the data in the table into each data unit 110 at a corresponding position according to the positions of the data in the table, and arranges the data units 110 within the display interface 100.

Different from the foregoing implementation aspect, this implementation aspect is further added with mask units 180. The mask units 180 (indicated by black solid line frames in FIG. 4A) are used to cover each data unit 110 in the display interface 1 00. The mask unit 180 may adopt a ground color of the display interface 100 as its mask color. If the ground color of the display interface 100 is a pattern, the mask unit 180 is patterned according to the display interface 100, and achieves a seamless display with the pattern of the display interface 100. FIG. 4C is a schematic view of a display interface and mask units.

Next, the presenter sets the display properties of the mask units 180 one by one according to the sequence of the presentation. The presenter may control the display properties of the mask units 180 according to the main switching element 120, the column switching elements 130, or the row switching elements 130. When the display properties of the mask units 180 are turned on, the mask units 180 may cover the display of the data units 110 (in FIG. 4C, black mesh points indicate that the data units 110 are covered). On the contrary, when the display properties of the mask units 180 are turned off, the mask units 180 become transparent, such that the viewers may clearly see the content to be presented by the data units 110. In addition, FIG. 4D is a schematic view before the mask units are switched. In FIG. 4D, the black solid line frames indicate that the mask units 180 are in a transparent state, such that the presentation data in the data units 110 is displayed on the frame.

In the above embodiments, all the data units in the display interface 100 of the presentation system are controlled by the main switching element so as to be displayed or concealed at the same time. The whole column or the whole row of the data units are controlled by the column switching elements or the row switching elements so as to be displayed or concealed at the same time. A single data unit to be displayed or concealed is controlled by the corresponding grid switching element. In another embodiment, a property of a display mode may be attributed to each data unit, for example, flickering, color changing, and so on. Thus, when all the data units are controlled to be displayed at the same time by the main switching element or the data units are controlled by other switching elements, the data units may be displayed in a highlighted manner, so as to attract more attention of the listeners.

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module, such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, and firmware to implement those methods and systems described above. The functionality provided for in the software, hardware, or both may be combined into fewer components or further separated into additional components. Additionally, the components may advantageously be implemented to execute on one or more computing devices. As used herein, “computing device” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A matrix display interface for a presentation system, adapted to selectively display presentation data on a display interface when the presentation system is operated on a computer, the matrix display interface comprising:
a plurality of data units, arranged on the display interface, and written with the presentation data in advance;
a main switching element, having a first prompt text, for switching to display or conceal all the data units when clicked;
at least one column switching element, having a second prompt text, for switching to display or conceal a whole column of the corresponding data units when clicked;
at least one row switching element, having a third prompt text, for switching to display or conceal a whole row of the corresponding data units when clicked; and
at least one grid switching element, corresponding to the data units, for switching to display or conceal the corresponding data units when clicked.

2. The matrix display interface for a presentation system according to claim 1, wherein the presentation data written into the data units is one selected from a group consisting of texts, graphics, video files, and audio files.

3. The matrix display interface for a presentation system according to claim 1, wherein an arrangement mode of the data units is one selected from a group consisting of no-interval checkerboard arrangement, equal interval checkerboard arrangement, and unequal interval checkerboard arrangement.

4. The matrix display interface for a presentation system according to claim 1, wherein when a horizontal axis coordinates range of the data units and a horizontal axis coordinates range of the column switching elements are intersected, it is determined that the data units are corresponding to the column switching elements.

5. The matrix display interface for a presentation system according to claim 1, wherein when a vertical axis coordinates range of the data units and a vertical axis coordinates range of the row switching elements are intersected, it is determined that the data units are corresponding to the row switching elements.

6. The matrix display interface for a presentation system according to claim 1, wherein an arrangement mode of the column switching elements is one selected from a group consisting of single-row adjacent juxtaposition, single-row interval juxtaposition, multiple-row adjacent juxtaposition, and multiple-row interval juxtaposition.

7. The matrix display interface for a presentation system according to claim 1, wherein an arrangement mode of the row switching elements is one selected from a group consisting of single-column adjacent juxtaposition, single-column interval juxtaposition, multiple-column adjacent juxtaposition, and multiple-column interval juxtaposition.

8. The matrix display interface for a presentation system according to claim 1, wherein a display type of the main switching element is one selected from a group consisting of a transparent element with a ground color, an opaque element with a ground color, a transparent element without a ground color, and an opaque element without a ground color.

9. The matrix display interface for a presentation system according to claim 1, wherein a display type of the column switching elements is one selected from a group consisting of a transparent element with a ground color, an opaque element with a ground color, a transparent element without a ground color, and an opaque element without a ground color.

10. The matrix display interface for a presentation system according to claim 1, wherein a display type of the row switching elements is one selected from a group consisting of a transparent element with a ground color, an opaque element with a ground color, a transparent element without a ground color, and an opaque element without a ground color.

11. The matrix display interface for a presentation system according to claim 1, wherein a display type of the grid switching elements is one selected from a group consisting of a transparent element with a ground color, an opaque element with a ground color, a transparent element without a ground color, and an opaque element without a ground color.

12. The matrix display interface for a presentation system according to claim 1, further comprising a special effect switch having a fourth prompt text, for playing a display special effect of the data units.

13. The matrix display interface for a presentation system according to claim 1, wherein the display special effect is to switch any one of a font type, a font size, a font color, a flicker frequency, and fade-out or fade-in of the presentation data written into the data units.

14. A matrix display interface for a presentation system, adapted to selectively display presentation data on a display interface when the presentation system is operated on a computer, the matrix display interface comprising:
a plurality of data units, arranged on the display interface, and written with the presentation data in advance; and
at least one switching element, having a prompt text, for switching to display or conceal the corresponding data units when clicked.

15. The matrix display interface for a presentation system according to claim 14, wherein the presentation data written into the data units is one selected from a group consisting of texts, graphics, video files, and audio files.

16. The matrix display interface for a presentation system according to claim 14, wherein an arrangement mode of the data units is one selected from a group consisting of no-interval checkerboard arrangement, equal interval checkerboard arrangement, and unequal interval checkerboard arrangement.

17. The matrix display interface for a presentation system according to claim 14, wherein the switching elements are selected from a group consisting of a main switching element, at least one column switching element, at least one row switching element, and at least one grid switching element.

18. The matrix display interface for a presentation system according to claim 14, wherein the main switching element is used for switching to display or conceal all the data units.

19. The matrix display interface for a presentation system according to claim 14, wherein the column switching element is used for switching to display or conceal a whole column of the corresponding data units.

20. The matrix display interface for a presentation system according to claim 14, wherein the row switching element is used for switching to display or conceal a whole row of the corresponding data units.

21. The matrix display interface for a presentation system according to claim 14, wherein the grid switching element is used for switching to display or conceal the corresponding data units.

22. A matrix display interface for a presentation system, adapted to selectively display presentation data on a display interface when the presentation system is operated on a computer, the matrix display interface comprising:
a plurality of data units, arranged on the display interface, and written with presentation data in advance;
a plurality of mask units, covered on positions of the data units, for switching the display of the presentation data in the data units;
a main switching element, having a first prompt text, for switching to display or conceal all the mask units when clicked;
at least one column switching element, having a second prompt text, for switching to display or conceal a whole column of the corresponding mask units when clicked;
at least one row switching element, having a third prompt text, for switching to display or conceal a whole row of the corresponding mask units when clicked; and
at least one grid switching element, corresponding to the data units, for switching to display or conceal the corresponding mask units when clicked.

23. The matrix display interface for a presentation system according to claim 22, wherein the presentation data written into the data units is one selected from a group consisting of texts, graphics, video files, and audio files.

24. The matrix display interface for a presentation system according to claim 22, wherein a display type of the main switching element is one selected from a group consisting of a transparent element with a ground color, an opaque element with a ground color, a transparent element without a ground color, and an opaque element without a ground color.

25. The matrix display interface for a presentation system according to claim 22, wherein a display type of the column switching elements is one selected from a group consisting of a transparent element with a ground color, an opaque element with a ground color, a transparent element without a ground color, and an opaque element without a ground color.

26. The matrix display interface for a presentation system according to claim 22, wherein a display type of the row switching elements is one selected from a group consisting of a transparent element with a ground color, an opaque element with a ground color, a transparent element without a ground color, and an opaque element without a ground color.

27. The matrix display interface for a presentation system according to claim 22, wherein a display type of the grid switching elements is one selected from a group consisting of a transparent element with a ground color, an opaque element with a ground color, a transparent element without a ground color, and an opaque element without a ground color.

28. The matrix display interface for a presentation system according to claim 22, further comprising a special effect switch having a fourth prompt text, for playing a display special effect of the data units.

29. The matrix display interface for a presentation system according to claim 22, wherein the display special effect is to switch any one of a font type, a font size, a font color, a flicker frequency, and fade-out or fade-in of the presentation data written into the data units.
